(19) United States
(12) Patent Application Publication
(10) Pub. No.: US 2002/0005060 A1
(43) Pub. Date: Jan. 17, 2002

(54) CIRCUIT ARRANGEMENT FOR INTERFERENCE-FREE SIGNAL EVALUATION

(76) Inventors: STEFAN UNLAND, VAIHINGEN-KLEINGLATTBACH (DE); DAVIDE BURO, REUTLINGEN (DE); JUERGEN SPACHMANN, SERSHEIM (DE)

Correspondence Address: STRIKER STRIKER & STENBY, 103 EAST NECK ROAD, HUNTINGTON, NY, 11743

(21) Appl. No.: 09/331,018

(22) PCT Filed: Nov. 7, 1997
(86) PCT No.: PCT/DE97/02595

(30) Foreign Application Priority Data
Dec. 24, 1996 (DE) 196 54 329.0

(51) Int. Cl. G01L 23/22

(52) U.S. Cl. 73/35.01

(57) ABSTRACT

A circuit arrangement for the interference-free evaluation of signals is disclosed, with which output signals of sensors can be evaluated; two inputs are needed for each sensor. If a ground-referred signal evaluation is to be done, then only one input is needed for each sensor. The evaluation is done using differential circuitry; in the operating mode with ground reference, the differential signal processing is done by employing an internally generated reference voltage. The choice of operating mode of the circuit arrangement can be made from outside freely via its own control pin.

The invention relates to an evaluation circuit for the interference-free evaluation of signals, in particular output signals of knocking sensors, as generically defined by the preamble to the main claim.

### PRIOR ART

It is known for signals which are carried for instance by a sensor on to an evaluation unit, to be transmitted between the sensor and the evaluation unit with the aid of a shielded line. The shielding protects the signal transmission against interference and adulteration of the signal. Shielding a line is relatively expensive, however, and still is no guarantee that no signal will not be adulterated after all.

German Published, Non-Examined Patent Application DE-OS 42 22 475 therefore proposes an arrangement for blanking out interference signals on signal lines, which assures that an interference-free original signal can be evaluated. In this known arrangement, the transmission of an original signal is done in a first signal line, and the transmission of an inverted or differentiated original signal is done in a second signal line. The previously inverted or differentiated signal is reinverted or integrated again at the end of the signal line. After that, this signal is linked in an AND gate with the unaltered transmitted signal, and as a result an interference-free original signal is obtained at the output of the AND gate. If a ground cable is additionally carried along in the cable between the sensor and the evaluation arrangement, then overvoltage protection can be achieved by incorporating Zener diodes between the signal lines and ground.

### ADVANTAGES OF THE INVENTION

The circuit arrangement of the invention for the interference-free evaluation of signals, having the characteristics of claim 1, has the advantage over the prior art that economical signal evaluation which is nevertheless secure against interference can be accomplished, and common-mode interference is largely avoided. This advantage is attained by constructing the signal evaluation circuit using differential circuitry in what is known as the “switched-capacitor technique”. It is especially advantageous that the operating mode of the evaluation circuit can be selected to be either symmetrical or asymmetrical, or in other words that the sensors whose output signals are to be evaluated can be connected to the evaluation circuit in such a way that in the asymmetrical operating mode, a connection with ground reference is possible, while in the symmetrical operating mode a potential-free connection is possible. Because of the advantageous selectability of the operating mode, the circuit arrangement of the invention can be operated both with conventional sensors, such as conventional knocking sensors with shielded connection lines, and with sensors with unshielded (twisted-pair) lines. This combination of the circuit arrangement with sensors, such as knocking sensors with unshielded lines, is an advantageous way of enabling economical and yet interference-proof realization of a knocking evaluation system.

A particular advantage of the circuit arrangement of the invention is attained by the capability of defining the operating mode from outside. This definition can be done for instance via a programmable control pin. It is thus possible to adapt the evaluation circuit from outside to the desired requirements, that is, for the symmetrical or asymmetrical operating mode, and as a result if there are four signal inputs, for instance, either four sensors are connectable asymmetrically or in other words with ground reference, or two sensors are connectable symmetrically or in other words in potential-free fashion.

The further advantages of the invention are attained by the provisions recited in the dependent claims.

### DRAWING

One exemplary embodiment of the invention is shown in the sole figure of the drawing and is explained in further detail in the ensuing description.

### DESCRIPTION

In the drawing, an exemplary embodiment of the invention is shown in which the output signals of a knocking sensor K1 are to be evaluated. The knocking sensor K1 has two connection terminals A1, A2, by way of which the knocking sensor K1 is connected to the signal processing circuit S. Between the knocking sensor K1 and signal processing circuit S is a passive coupling network. This passive coupling network includes a capacitor CL, which is located between the connection terminals A1, A2 of the knocking sensor K1, and two parallel-connected capacitors C1a and C2a. The resistors R1b, R2b are located between these two capacitors. The capacitor C1a is also connected to the input E1 via a resistor R1a, ad the capacitor C2a is connected to the input E2 of the signal processing circuit S via the resistor R2a. The connection between the two resistors R1b and R2b leads to a reference voltage input, to which the voltage Ur is applied.

The signal processing circuit S includes a differential input amplifier V, which is connected to the two input E1 and E2. Downstream of the amplifier V are signal processing stages, not shown, which for instance include at least one bandpass filter and/or one rectifier and/or one integrator and are for instance also designed using differential circuitry.

These signal processing stages are followed by an output stage A, which is capable of converting the differential signal into an asymmetrical signal with ground reference and makes this signal available for further evaluation via an analog/digital converter of a microcomputer μc.

In the exemplary embodiment shown in the drawing, the unshielded terminals of a knocking sensor K1 are connected potential-free, for instance via twisted lines, to the two inputs E1, E2 of the signal processing circuit S. The input stage of this evaluation circuit is embodied, for the sake of suppressing common-mode interference, as a differential amplifier stage, and in particular as a switched-capacitor amplifier with multistage-adjustable amplification. The downstream signal processing stages can also be designed using differential circuitry. This is true particularly for band pass filters, rectifiers or integrators. The embodiment employing the switched-capacitor technique allows an economical space-saving integration of the requisite analog functions in semiconductor processors, for instance using HCMOS technology.

Since the output stage of the signal processing circuit can convert the differential signal into an asymmetrical signal with ground reference that is then finally supplied to the microcomputer, various signal evaluations can be achieved. In a knocking detection system that includes a plurality of knocking sensors, such as two knocking sensors, which are each connected via two inputs to the signal processing circuit, these two knocking sensors can be connected symmetrically or in other words in potential-free fashion. In this mode, the knocking sensor signals are then processed fully differentially.

If conversely a signal processing circuit with four inputs is used, so as to evaluate up to four knocking sensors, an asymmetrical operating mode is selected, in which the knocking sensors are connected with ground reference to the signal processing circuit. In this mode, a fixed reference voltage Ur generated in the signal processing circuit serves as a reference voltage for the differential signal processing.

If the signal processing circuit has an additional externally accessible control pin, then the operating mode can be programmed from outside in each case via this control pin. Accordingly the operating mode can be chosen from outside, so that with the same number of inputs and the same signal processing circuit, either two knocking sensors can be connected potential-free, or up to four knocking sensors with ground reference can be connected, and suitable signal processing can be done in one or the other operating mode.

By the choice of operating mode, sensors with unshielded (twisted-pair) lines between the sensor and signal processing, or also sensors with shielded connection lines, can be connected. The combination of the circuit arrangement, which can be constructed as an evaluation component, with knocking sensors with unshielded lines makes a simple, economical and yet interference-proof realization of a knocking evaluation system possible. In the exemplary embodiment, an evaluation of knocking sensor signals is described, but the use of the circuit arrangement of the invention is not limited to knocking sensors; instead, it can also be employed in conjunction with the evaluation of other sensors.

1. A circuit arrangement for the interference-free evaluation of signals, in particular of output signals of at least one knocking sensor, having at least two inputs to which one sensor can be connected potential-free or two sensors can be connected with ground reference, having a differential amplifier which is connected to the inputs, and having an output stage, which optionally converts the differential signal furnished by the amplifier into a signal with ground reference, characterized in that the circuit arrangement can be operated in two operating modes, and the first operating mode is employed with potential-free connection and a symmetrical signal, and the second operating mode is employed with a potential-referred connection and an asymmetrical signal.

2. The circuit arrangement of claim 1, characterized in that the operating mode can be switched over from outside between symmetrical and asymmetrical.

3. The circuit arrangement of claim 2, characterized in that the choice of the operating mode can be programmed from outside via a control pin.

4. The circuit arrangement of one of the foregoing claims, characterized in that a passive coupling network is present between the sensor or sensors and the actual signal processing circuit.

5. The circuit arrangement of claim 4, characterized in that the passive coupling network is symmetrical and includes a first capacitor (CL) between the terminals of the sensor and two further capacitors (C1a, C2a), which are connected on the one hand to the sensor and on the other, via resistors (R1a, R2a), to the inputs (E1, E2) of the signal processing circuit (S) and, via resistors (R1b, R2b), to a terminal to which a reference voltage (Ur) is applied.

6. The circuit arrangement of one of the foregoing claims, characterized in that signal processing stages, and in particular at least one bandpass filter and/or at least one rectifier and/or at least one integrator, are connected downstream of the differential amplifier (V).

7. The circuit arrangement of claim 6, characterized in that the components in the group comprising the amplifier, bandpass filter, rectifier, and integrator are constructed employing the switched-capacitor technique.

8. The circuit arrangement of one of the foregoing claims, characterized in that the output stage (A) of the signal processing circuit (S) is connected to a microcomputer via an analog/digital converter, and the signal evaluation is done in this microcomputer.

9. The circuit arrangement of one of the foregoing claims, characterized in that it is employed for evaluating the output signals of two knocking sensors, which are connected via unshielded lines in potential-free fashion each to two inputs of the signal processing circuit, or for the evaluation of the output signals of four knocking sensors, which are connected by shielded lines each to one input of the signal processing circuit.
